(19) United States
(12) Patent Application Publication
(10) Pub. No.: US 2012/0040673 A1
(43) Pub. Date: Feb. 16, 2012

(54) Method of Handling Measurement Procedure and Related Communication Device

(76) Inventors: Wenping Ying, Taoyuan County (TW); Chien-Jen Huang, Taoyuan County (TW)

(21) Appl. No.: 13/018,432

(22) Filed: Feb. 1, 2011

Related U.S. Application Data
(60) Provisional application No. 61/300,036, filed on Feb. 1, 2010.
(60) Provisional application No. 61/302,557, filed on Feb. 9, 2010.

(51) Int. Cl. H04W 36/30

(52) U.S. Cl. 455/436

(57) ABSTRACT

A method of handling a measurement procedure for a mobile device in a wireless communication system is disclosed. The mobile device is equipped at least one receiver. The method includes camping on a serving cell; detecting a type of measurement; using the at least one receiver to perform the measurement according to the type of the measurement and receive system information; and performing a handover procedure to a target cell according to measurement results of the measurement and the system information. The serving cell is served by a first network, and the target cell is served by a second network.

### CROSS REFERENCE TO RELATED APPLICATIONS

This application claims the benefit of U.S. Provisional Application No. 61/300,036, filed on Feb. 1, 2010 and entitled “Enhanced measurement using a second receiver in CSFB”, and the benefit of U.S. Provisional Application No. 61/302,557, filed on Feb. 9, 2010 and entitled “Enhanced measurement using a second receiver in CSFB”, the contents of which are incorporated herein.

### BACKGROUND OF THE INVENTION

1. Field of the Invention

The application relates to a method used in a wireless communication system and related communication device, and more particularly, to a method for handing a measurement procedure in a wireless communication system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as to user equipments (UEs).

In order to maintain service continuity as a user moves, the UE must not only be connected to a serving cell but importantly also monitor their neighbor cells. This monitoring is an ongoing activity, since propagation conditions to different eNBs can change rapidly at any point in time. Typically the efforts by the UE and the network will always be directed toward providing service continuity on a preferred radio access technology (RAT) according to a given preference criterion which may, for example, include quality of service (QoS), cost or network operator. While the UE has service with its preferred network, the UE may be requested to perform mobility decision (handover, cell reselection or circuit switched (CS) fallback) towards other base stations from the same RAT or the different RAT according to a measurement report.

In the LTE system, the logical connection between the UE and the E-UTRAN is defined by radio resource control (RRC) connection states. The RRC connection states of the UE contain an RRC_IDLE state and an RRC_CONNECTED state. Mobility control in RRC_IDLE is UE-controlled (e.g. cell reselection) while in RRC_CONNECTED it is controlled by the E-UTRAN. The E-UTRAN decides to which cell the UE should handover in order to maintain the radio link and preserve service continuity. The E-TURAN may take into account not only the radio link quality but factors such as UE capability, subscriber type and access restrictions. Normally, the E-UTRAN configures the UE to report measurements of the candidate target cells. The mobility from E-UTRA procedure covers the following type of mobility:
handover, i.e. A MobilityFromEUTRACommand message includes radio resources that have been allocated for the UE in the target cell;
cell change order, i.e. A MobilityFromEUTRACommand message may include information facilitating access of and/or connection establishment in the target cell, e.g. system information. Cell change order is applicable only to GERAN; and
enhanced CS fallback to CDMA2000 1xRTT, i.e. A MobilityFromEUTRACommand message includes radio resources that have been allocated for the UE in the target cell. The enhanced CS fallback to CDMA2000 1xRTT may be combined with concurrent handover or redirection to CDMA2000 HRPD.

A UE with multi-RAT capability must measure not only the reception quality of the current cell, but also that of the neighboring cells of other RAT networks during an active call. The evaluation of this measurement is necessary in order to perform an inter-RAT cell change, e. g. from E-UTRAN to UTRAN or GERAN. This measurement will introduce latency due to the single radio capability, i.e. measurement should be performed based on compressed mode, measurement gap or turn-away mechanism when the traffic channel is active.

### SUMMARY OF THE INVENTION

A method of handling a measurement procedure in a wireless communication system and a related communication device are provided.

A method of handling a measurement procedure for a mobile device in a wireless communication system is disclosed. The mobile device is equipped at least one receiver. The method includes camping on a serving cell; detecting a type of measurement; using the at least one receiver to perform the measurement according to the type of the measurement and receive system information; and performing a handover procedure to a target cell according to measurement results of the measurement and the system information. The serving cell is served by a first network, and the target cell is served by a second network.

A communication device for handling a measurement procedure in a wireless communication system is disclosed. The communication device is equipped at least one receiver and includes means for camping on a serving cell; means for detecting a type of measurement; means for using the at least one receiver to perform the measurement according to the type of the measurement and receive system information and means for performing a handover procedure to a target cell according to measurement results of the measurement and the system information. The serving cell is served by a first network, and the target cell is served by a second network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary wireless communication system.

FIG. 2 is a schematic diagram of an exemplary communication device.

FIG. 3 illustrates the program code in FIG. 2

FIG. 4 is a flow chart of an exemplary process.

FIG. 5 is a flow chart of an exemplary Type A enhanced measurement procedure.

FIG. 6 is a flow chart of an exemplary Type B enhanced measurement procedure.

### DETAILED DESCRIPTION

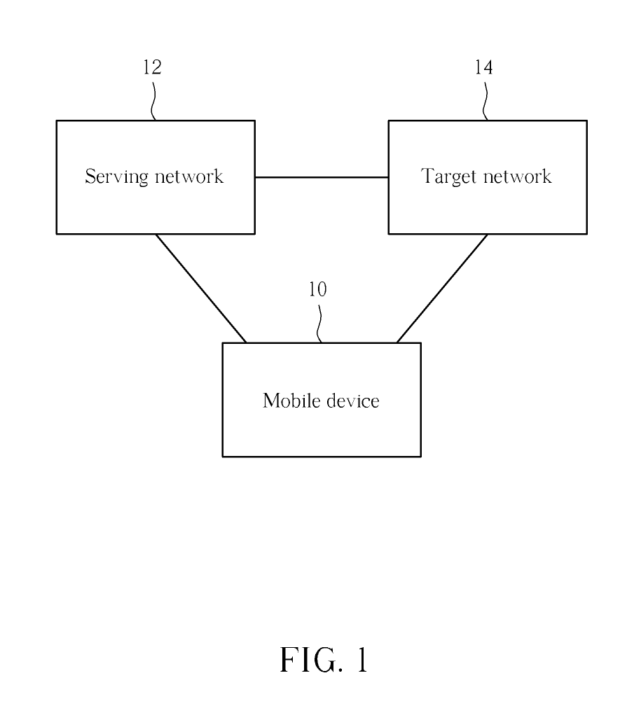

Please refer to FIG. 1, which simply illustrates an exemplary wireless communication system 10. In FIG. 1, a serving network 12 and a target network 14 employ different radio access technologies (RATs), and the mobile device 10 supporting both of the RATs is served by the serving network 12. The serving network 12 supports a single service domain and maybe referred as to a LTE (long-term evolution). The target network 14 supports multiple service domains and may be referred as to a network of a UMTS (Universal Mobile Telecommunications System) system, a GSM system, a GERAN Iu mode system or a CDMA (Code division multiple access) 2000 system. In the UMTS system, the network is referred as a Universal Terrestrial Radio Access Network (UTRAN) comprising a radio network controller (RNC) and a plurality of NBs (Node Bs); In the GSM/GERAN Iu mode system, the network is referred as a GERAN comprising a base station controller (BSC) and a plurality of base stations; In the LTE system, the network is referred as a evolved-UTRAN (E-UTRAN) comprising a plurality of eNBs (evolved-Node Bs). The mobile device is referred as to a user equipment (UE) or a mobile station (MS) supporting the abovementioned RATs and may be a device such as a mobile phone, a computer system, etc. Besides, the networks 12 and 14 and the mobile device can be seen as a transmitter or receiver according to transmission direction, e.g., for uplink (UL), the mobile device is the transmitter and the networks 12 and 14 are the receivers, and for downlink (DL), the networks 12 and 14 are the transmitters and the mobile device is the receiver. The serving network 12 can trigger a handover procedure based on radio conditions. To facilitate the handover procedure, the serving network 12 may configure the mobile device to perform measurement reporting. The measurement report may include different types of measurements to provide information of all radio conditions for the serving network 12. Thus, the serving network 12 may decide when the handover procedure should take place.

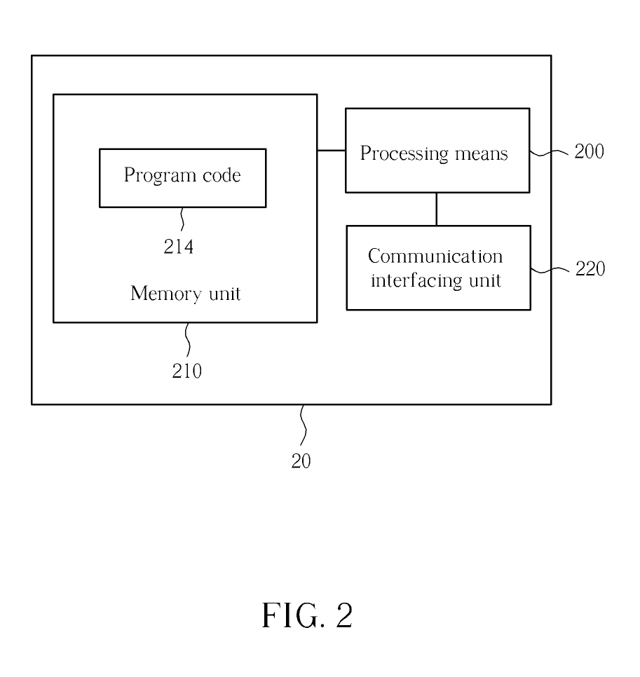

Please refer to FIG. 2, which is a schematic diagram of an exemplary communication device 20. The communication device 20 can be the mobile device or the network shown in FIG. 1 and includes a processor 200, a computer readable recording medium 210 and a communication interfacing unit 220. The computer readable recording medium 210 may be any data storage device that stores storage data 212, including program code 214, thereafter read and processed by the processor 200. Examples of the computer readable recording medium 210 includes a subscriber identity module (SIM), read-only memory (ROM), random-access memory (RAM), CD-ROMs, magnetic tapes, hard disks, optical data storage devices, and carrier waves (such as data transmission through the Internet). The communication interfacing unit 220 is preferably a radio transceiver for wirelessly communicating with other communication devices and can transform process results from the processor 200 into radio signals.

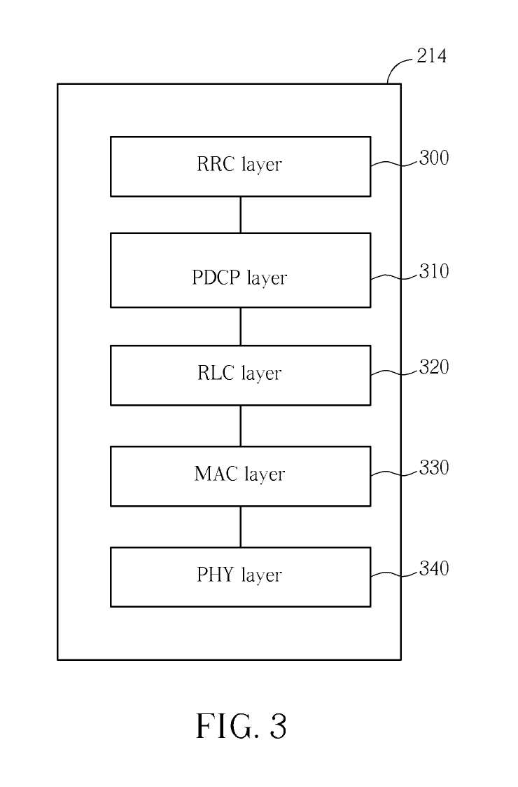

Please refer to FIG. 3, which illustrates the program code 214 in FIG. 2. The program code 214 includes program code of multiple communications protocol layers, which from top to bottom are a radio resource control (RRC) layer 300, a packet data convergence protocol (PDCP) layer 310, a radio link control (RLC) layer 320, a medium access control (MAC) layer 330 and a physical (PHY) layer 340. When the communication device 20 is referred as to the mobile device shown in FIG. 1, the RRC layer 300 of the communication device 20 obtains various measurement results from the MAC layer 330 and the physical layer 340. Then, the RRC layer 300 generates a measurement report based on the measurement results. The measurement report is sent to the network (e.g. E-UTRAN) via a “MeasurementReport” message for reporting the communication system environment situation around the communication device 20, e.g., communication quality of one or more cells around the communication device 20. The communication device 20 may set measurement information elements (e.g. MeasResults) within the MeasurementReport message. When the communication device 20 is referred as to the network shown in FIG. 1, the RRC layer 300 of the network may provide the measurement configuration applicable for the UE by sending dedicated signalling, e.g., the RRCConnectionReconfiguration.

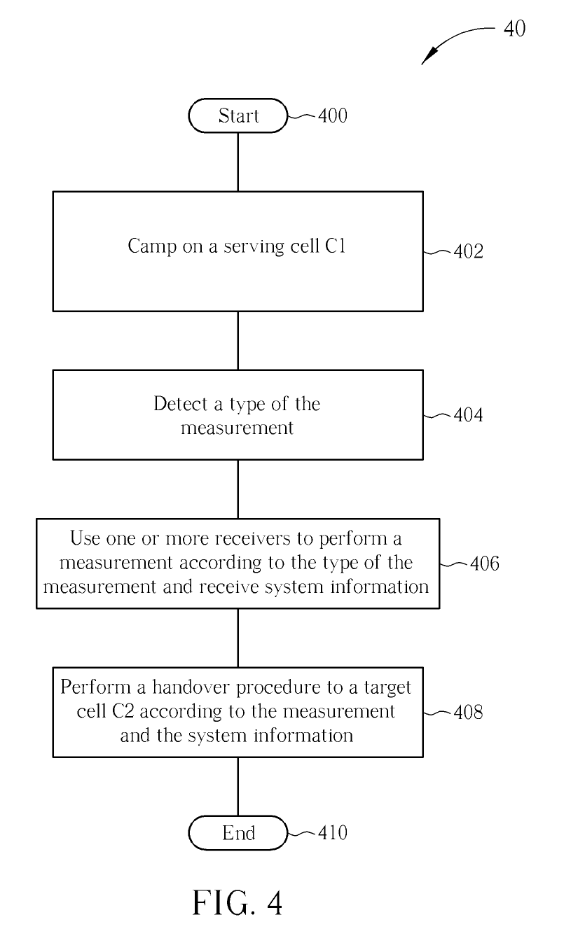

Please refer to FIG. 4, which is a flow chart of an exemplary process 40. The process 40 is used for handling a measurement procedure for a UE in the wireless communication system 10. The UE is equipped with one or more receivers and capable of supporting more than two radio access technologies, such as LTE system, UMTS system, a GSM system, a GERAN Iu mode system or a CDMA system.

The process 40 can be compiled into the program code 214 and include the following steps:

Step 400: Start.

Step 402: Camp on a serving cell C1.

Step 404: Detect a type of the measurement.

Step 406: Use one or more receivers to perform a measurement according to the type of the measurement and receive system information.

Step 408: Perform a handover procedure to a target cell C2 according to the measurement and the system information.

Step 410: End.

According to the process 40, the UE camps on the serving cell C1. A network NT1 serving the serving cell C1 may initiate the measurement procedure by sending a measurement control message. The network NT1 could be the serving network 12, referred as to LTE network (e.g. E-UTRAN) using LTE-FDD (LTE-Frequency Division Duplex) or LTE-TDD (LTE-Time Division Duplex) technology. Then, the UE may detect the type of measurement. The type of the measurement may be referred as to a Type A enhanced measurement or a Type B enhanced measurement. The UE use the enhancement measurement if it is indicated by a parameter REPORT_TYPE. Afterwards, the UE may use one or more receivers to perform the measurement according to the type of the measurement and to receive system information. The UE performs a background measurement and a network triggered measurement with one or more receivers when the type of the measurement is the Type A enhanced measurement and performs the network triggered measurement with one or more receivers when the type of the measurement is the Type B enhanced measurement. The measurement and the system information are associated with the serving cell C1 and neighbouring cells of the serving cell C1. If the UE finds a target cell C2 with a better quality of service (QoS) according to the measurement and the system information, the UE perform a handover procedure to the target cell C2. The target cell C2 is served by a network NT2. The network NT2 could be the target network 14, referred as to the network of UMTS system (e.g. UMTS-FDD or UMTS-TDD), a GSM system, a GPRS system or a CDMA system (e.g. CDMA 1xRTT or CDMA 1xEVDO). Thus, the UE measures the neighbouring cells of the serving cell C1 and reads the system information of the neighbouring cells in advance, using one or more receivers. When the UE performs inter-frequency or inter-RAT handover, the beforehand measurement and message exchange help the UE save more time during the handover procedure, thereby improving system efficiency.

Please note that the process 40 is recursive. This means after the UE camps on the target cell C2, the UE repeats the steps 400˜410. For example, the UE may perform system information acquisition to the target cell C2 after the handover is completed.

In the case of the Type A enhanced measurement, the UE initiates the background measurement directly. The background measurement may be followed by the normal network triggered measurement. For the background measurement, the UE performs the background measurement over the serving cell C1 and the neighbouring cells of the serving cell C1. The neighbouring cells are listed in a neighbour cell list, which is acquired from the system information of the serving cell C1. The neighbour cell list may include cells operated over the same carrier frequency, different carrier frequencies or different RATs from the serving cell C1. The background measurement focuses on measuring the received signal level, received quality or path loss from the neighbouring cells.

Besides, the background measurement could be a periodic background measurement or an event-triggered background measurement. When the background measurement is periodic, the UE starts a background measurement timer when the background measurement is completed and stops the background measurement timer when the event trigger background measurement is initiated. When the background measurement timer expires the UE restarts a new background measurement. Namely, the UE periodically performs the background measurement to update results of the background measurement of the serving cell C1 and the neighbouring cells of the serving cell C1.

When the background measurement is even-triggered, the UE initiates the background measurement according to an event. The event triggers the background measurement for updating measurement results of the serving cell and neighbouring cells of the serving cell. The even may be referred as to a software triggered event, a hardware triggered event and a user triggered event. In the case of the software triggered event, it comes from a first even list. The first even list may include events reported from applications, protocol and operation system due to some internal software activities. In the case of the hardware triggered event, it comes from a second even list. The second even list may include events reported from all kinds of sensors/detectors on the UE due to some internal hardware activities. In the case of the user triggered event, it comes from a third event list. The third event list may include events reported when a user activity occurs and is detected by the UE via user interfaces. Regardless of the periodic background measurement or the even-triggered background measurement, the UE stops performing the background measurement when the handover procedure is initiated and restarts the background measurement when the handover fails.

For the network triggered measurement in both Type A enhanced measurement and Type B enhanced measurement, the UE initiates the network triggered measurement according to reception of a measurement control message. The measurement control message is sent from the network NT1.

If the measurement is completed, the UE sends measurement results of the measurement to the network NT1. That is, the UE sends the measurement results of the background measurement and the network triggered measurement to the network NT1 when the type of the measurement is the Type A enhanced measurement and sends the measurement results of the network triggered measurement to the network NT1 when the type of the measurement is the Type B enhanced measurement. Thus, the UE can go over the network triggered measurement procedure by sending back the measurement report based on the measurement results of the background measurement and the network triggered measurement when available.

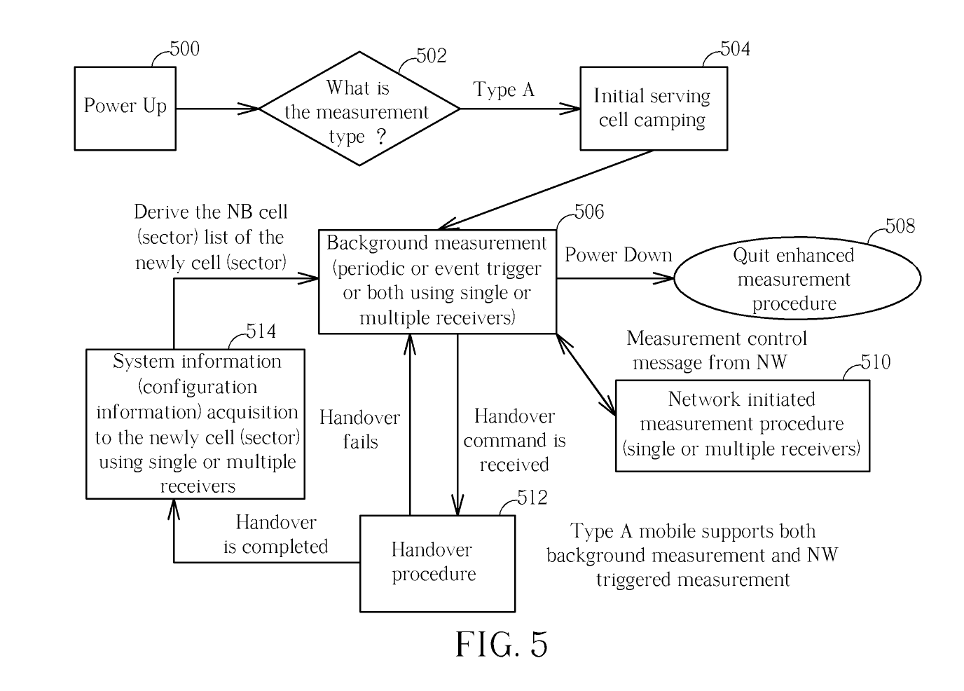

Please refer to FIG. 5, which is a flow chart of an exemplary Type A enhanced measurement procedure 50. In the step 500, the UE firstly powers up. In the steps 502 and 504, the UE performs initial serving cell camping after the Type A enhanced measurement is determined. Then, the UE performs background measurement (e.g. periodic or event-triggered), using one or more receiver in the step 506. If the UE powers down, then the UE goes to the step 508, quitting enhanced measurement procedure. In the step 510, the network initiates the network triggered measurement by sending the measurement control message. The network may direct the UE to handover to other cells according to a measurement report, sending a handover command. After the handover command is received, the UE performs the handover procedure in the step 512. When the handover is completed, the UE moves to a new cell. Once the UE camps on the new cell, the UE performs system information acquisition to the new cell, using one or more receivers in the step 514 and drives a neighbouring cell list of the new cell. Since the procedure 50 is recursive, the procedure 50 goes back to the step 506 after the step 514 is completed.

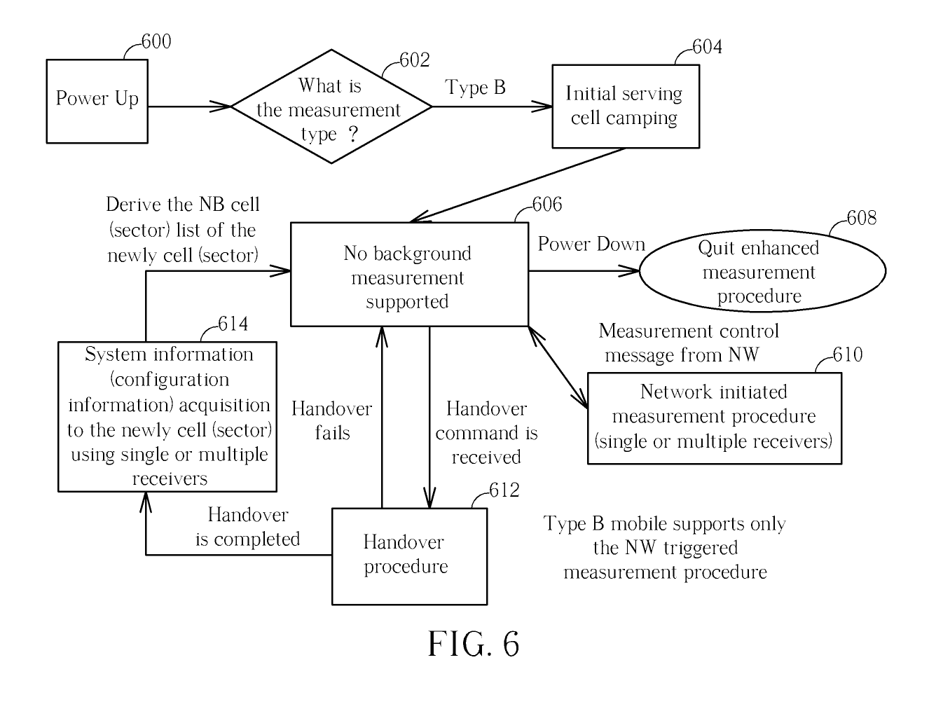

Please refer to FIG. 6, which is a flow chart of an exemplary Type B enhanced measurement procedure 60. In the step 600, the UE firstly powers up. In the steps 602 and 604, the UE performs initial serving cell camping after the Type B enhanced measurement is determined. However, in the step 606 the UE does not support background measurement. If the UE powers down, then the UE goes to the step 608, quitting enhanced measurement procedure. In the step 610, the network initiates the network triggered measurement by sending the measurement control message. The network may direct the UE to handover to other cells according to a measurement report, sending a handover command. After the handover command is received, the UE performs the handover procedure in the step 612. When the handover is completed, the UE moves to a new cell. Once the UE camps on the new cell, the UE performs system information acquisition to the new cell, using one or more receivers in the step 614 and drives a neighbouring cell list of the new cell. Since the procedure 60 is recursive, the procedure 60 goes back to the step 606 after the step 614 is completed.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20 in which the processor 200 processes the program code 214 related to the abovementioned processes and the processed results can perform feedback load reduction in the wireless communications system 20.

To sum up, according to examples, the UE may use one or more receivers to perform the measurement (e.g. the background measurement and the network triggered measurement) before the handover procedure. Consequently, the latency caused by the single radio capability can be reduced, thereby achieving time-saving and efficiency improvement.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling a measurement procedure for a mobile device in a wireless communication system, the mobile device equipped at least one receiver, the method comprising:
camping on a serving cell;
detecting a type of measurement;
using the at least one receiver to perform the measurement according to the type of the measurement and receive system information; and
performing a handover procedure to a target cell according to measurement results of the measurement and the system information;
wherein the serving cell is served by a first network, and the target cell is served by a second network.

2. The method of claim 1, wherein the first network is Evolved UMTS Terrestrial Radio Access Network (E-UTRAN) while the second network is UMTS Terrestrial Radio Access Network (UTRAN), GSM EDGE Radio Access Network (GERAN) or Code Division Multiple Access (CDMA) system.

3. The method of claim 1, wherein the measurement and the system information are associated with the serving cell and neighbouring cells of the serving cell.

4. The method of claim 1, wherein the type of the measurement is a Type A enhanced measurement or a Type B enhanced measurement and the step of using the at least one receiver to perform the measurement according to the type of the measurement comprises performing a first background measurement and a network triggered measurement when the type of the measurement is the Type A enhanced measurement and performing the network triggered measurement when the type of the measurement is the Type B enhanced measurement.

5. The method of claim 4 further comprising initiating the measurement directly when the measurement is the background measurement and initiating the measurement according to reception of a measurement control message when the measurement is the network triggered measurement, wherein the measurement control message is sent from a network.

6. The method of claim 4 further comprising:
stopping performing the first background measurement when the handover procedure is initiated; and
restarting the first background measurement when the handover fails.

7. The method of claim 4, wherein the first background measurement is a periodic background measurement and the step of performing the first background measurement comprises starting a background measurement timer when the first background measurement is completed, stopping the background measurement timer when the event trigger background measurement is initiated and starting a second background measurement when the background measurement timer expires.

8. The method of claim 4, wherein the first background measurement is an event triggered background measurement and the step of performing the first background measurement further comprises initiating the first background measurement according to an event, wherein the event triggers the first background measurement for updating the measurement results of the serving cell and neighbouring cells of the serving cell.

9. The method of claim 8, wherein the even is a software triggered event, a hardware triggered event and a user triggered event.

10. The method of claim 1 further comprising sending the measurement results of the measurement to the first network.

11. A communication device for handling a measurement procedure in a wireless communication system, the communication device equipped at least one receiver comprising:
means for camping on a serving cell;
means for detecting a type of measurement;
means for using the at least one receiver to perform the measurement according to the type of the measurement and receive system information; and
means for performing a handover procedure to a target cell according to measurement results of the measurement and the system information;
wherein the serving cell is served by a first network, and the target cell is served by a second network.

12. The communication device of claim 11, wherein the first network is Evolved UMTS Terrestrial Radio Access Network (E-UTRAN) while the second network is UMTS Terrestrial Radio Access Network (UTRAN), GSM EDGE Radio Access Network (GERAN) or Code Division Multiple Access (CDMA) system.

13. The communication device of claim 11, wherein the measurement and the system information are associated with the serving cell and neighbouring cells of the serving cell.

14. The communication device of claim 11, wherein the type of the measurement is a Type A enhanced measurement or a Type B enhanced measurement and the means for using the at least one receiver to perform the measurement according to the type of the measurement further performs a first background measurement and a network triggered measurement when the type of the measurement is the Type A enhanced measurement and performs the network triggered measurement when the type of the measurement is the Type B enhanced measurement.

15. The communication device of claim 14, wherein the means for using the at least one receiver to perform the measurement according to the type of the measurement further initiates the measurement directly when the measurement is the background measurement and initiates the measurement according to reception of a measurement control message when the measurement is the network triggered measurement, wherein the measurement control message is sent from a network.

16. The communication device of claim 14 further comprising:
means for stopping performing the first background measurement when the handover procedure is initiated; and
means for restarting the first background measurement when the handover fails.

17. The communication device of claim 14, wherein the first background measurement is a periodic background measurement and the means for performing the first background measurement further starts a background measurement timer when the first background measurement is completed and stops the background measurement timer when the event trigger background measurement is initiated and starts a second background measurement when the background measurement timer expires.

18. The communication device of claim 14, wherein the first background measurement is an event triggered background measurement, the means for performing the first background measurement further initiates the first background measurement according to an event, wherein the event triggers the first background measurement for updating the measurement results of the serving cell and neighbouring cells of the serving cell.

19. The communication device of claim 18, wherein the even is a software triggered event, a hardware triggered event and a user triggered event.

20. The communication device of claim 11 further comprising means for sending the measurement results of the measurement to the first network.
